(19) United States
(12) Patent Application Publication
(10) Pub. No.: US 2018/0201070 A1
(43) Pub. Date: Jul. 19, 2018

(54) CONSTRUCTION VEHICLE TIRE

(71) Applicant: BRIDGESTONE CORPORATION, Tokyo (JP)

(72) Inventor: Tomoo HASEGAWA, Tokyo (JP)

(73) Assignee: BRIDGESTONE CORPORATION, Tokyo (JP)

(21) Appl. No.: 15/742,634

(22) PCT Filed: Jul. 8, 2016
(86) PCT No.: PCT/JP2016/070224

§ 371 Date: Jan. 8, 2018

(30) Foreign Application Priority Data
Jul. 9, 2015 (JP) 2015-137670

(51) Int. Cl. B60C 11/03; B60C 9/20

(52) U.S. Cl. CPC B60C 11/0306; B60C 9/20; B60C 2009/2016; B60C 2011/0341; B60C 2011/0372; B60C 2200/065

(57) ABSTRACT

A tread part of a tire for a construction vehicle is partitioned in plural by circumferential grooves extending in a tire circumferential direction, and a tread end and a lateral groove. The lateral groove has, on at least one side of a tire equator line, an inflection point where the orientations of concavities and convexities relative to the tire circumferential direction change progressively outward in the tire width direction. The lateral groove extends from the inflection point toward one side in the tire circumferential direction and toward an outer side in the tire width direction, and further extends toward the other side in the tire circumferential direction and toward the outer side in the tire width direction, so as the lateral groove to have a bent groove part that forms a curved convex land portion with respect to the one side in the tire circumferential direction.

### TECHNICAL FIELD

The present invention relates to a construction vehicle tire including a tread part.

### BACKGROUND ART

Conventionally, in a tread part, a heavy load tire including a protection belt ply including two protection belts, a main crossed belt ply including two main crossed belts, and a small crossed belt ply including two small crossed belts is known (See Patent Literature 1).

In such a tire, the main crossed belt ply is arranged on the outer side of the small crossed belt ply in the tire radial direction. The protection belt ply is arranged on the outer side of the main crossed belt ply in the tire radial direction.

The angle formed by the cord constituting the small crossed belt ply and the tire circumferential direction is in the range of 4 to 10°. The angle formed by the cord constituting the main crossed belt ply and the tire circumferential direction is in the range of 18 to 35°. The angle formed by the cord constituting the protection belt ply and the tire circumferential direction is in the range of 22 to 33°.

Therefore, in the tread part of such a tire, an angle formed by the cord constituting each belt ply and the tire circumferential direction U is small in the region in the vicinity of the tire equator line (center region), as compared with a region in the vicinity of the end of the tire in the tire width direction (shoulder region).

### CITATION LIST

### Patent Literature

### Patent Literature 1: WO 2013/157544

### SUMMARY OF INVENTION

### Technical Problem

In the above-described tire, the belt tension becomes small in a region where the angle formed by the cord constituting the belt ply and the tire circumferential direction is large. Therefore, such region shrinks greatly in the tire circumferential direction.

As a result, when the tire rotates, since the region in the vicinity of the end of the tire in the tire width direction in the tire circumferential direction shrinks greatly in the tire circumferential direction, the length of the region in the vicinity of the tire equator line in the tire circumferential direction is longer than that of the region in the vicinity of the end of the tire in the tire width direction in the tire circumferential direction.

Therefore, when the tire rotates, a force in the tire rotation direction (driving force) is generated in the region in the vicinity of the tire equator line, and a force opposite the tire rotation direction (braking force) is generated in the region in the vicinity of the end of the tire in the tire width direction. For this reason, a shearing force is generated near the boundary between both regions.

Further, in a case where a load is applied to such a tire after an inner pressure is applied, the degree of a deformation in the tire radial direction in the region in the vicinity of the tire equator line is different from that in the region in the vicinity of the end of the tire in the tire width direction. For this reason, a shearing force is generated near the boundary between both regions.

In particular, when the tire is mounted on the steering shaft, the shearing force is further increased by a force applied in the tire width direction due to the steering angle. In addition, when such the tire is mounted on a shaft on which a braking force acts, a shearing force is further increased by the braking force.

In particular, such a phenomenon is conspicuous in a heavy load tire configured so that the length of the land part in the tire width direction is 30% or more of the length of the tread part in the tire width direction.

In addition, such a phenomenon is conspicuous in, in particular, a construction vehicle tire among heavy load tires.

The present invention has been made in view of the above-described problems, and it is an object of the present invention to provide a construction vehicle tire in which uneven wear resistance is improved by suppressing a braking force generated in the vicinity of the end of the tire in the tire width direction at the time of tire rotation.

### Solution to Problem

In order to solve above-mentioned problems, a construction vehicle according to an aspect of the present invention includes a tread part. A land section is partitioned in plural by a circumferential groove extending in a tire circumferential direction, and a tread end of the tread part and a lateral groove extending in a curved shape along a tire width direction. The lateral groove on at least one side in the tire width direction with respect to a tire equator line includes an inflection point at which orientations of a concavity and a convexity with respect to the tire circumferential direction change progressively outward in the tire width direction. The lateral groove extends from the inflection point toward one side in the tire circumferential direction and toward an outer side in the tire width direction, and further extends toward the other side in the tire circumferential direction and toward the outer side in the tire width direction, so as the lateral groove to have a bent groove part that forms a curved convex land portion with respect to the one side in the tire circumferential direction.

### Advantageous Effects of Invention

One aspect of the present invention provides a construction vehicle tire in which uneven wear resistance is improved by suppressing a braking force generated in the vicinity of the end of the tire in the tire width direction at the time of tire rotation.

### BRIEF DESCRIPTION OF DRAWINGS

FIG. 1 is a cross-sectional view of a construction vehicle tire in the tire width direction along the tire radial direction according to an embodiment of the present invention.

FIG. 2 is an explanatory diagram illustrating a belt configuration of the construction vehicle tire according to the embodiment of the present invention.

FIG. 3 is a plan view illustrating a tread pattern in the construction vehicle tire according to the embodiment of the present invention.

FIG. 4 is a cross-sectional view of an inner lateral groove formed in the tread part of the construction vehicle tire according to the embodiment of the present invention.

FIG. 5 is a plan view illustrating variation of a tread pattern in the construction vehicle tire according to the embodiment of the present invention.

### DESCRIPTION OF EMBODIMENTS

Hereinafter, an embodiment of the present invention will be explained with reference to the attached drawings. In the following descriptions, same or similar parts are denoted by same or similar reference numerals; and the detailed description thereof is omitted as appropriate. Moreover, the embodiment described below is to show examples of embodying technical idea of the present invention, and various changes may be made in the technical idea of the present invention within the scope of the claims of the patent.

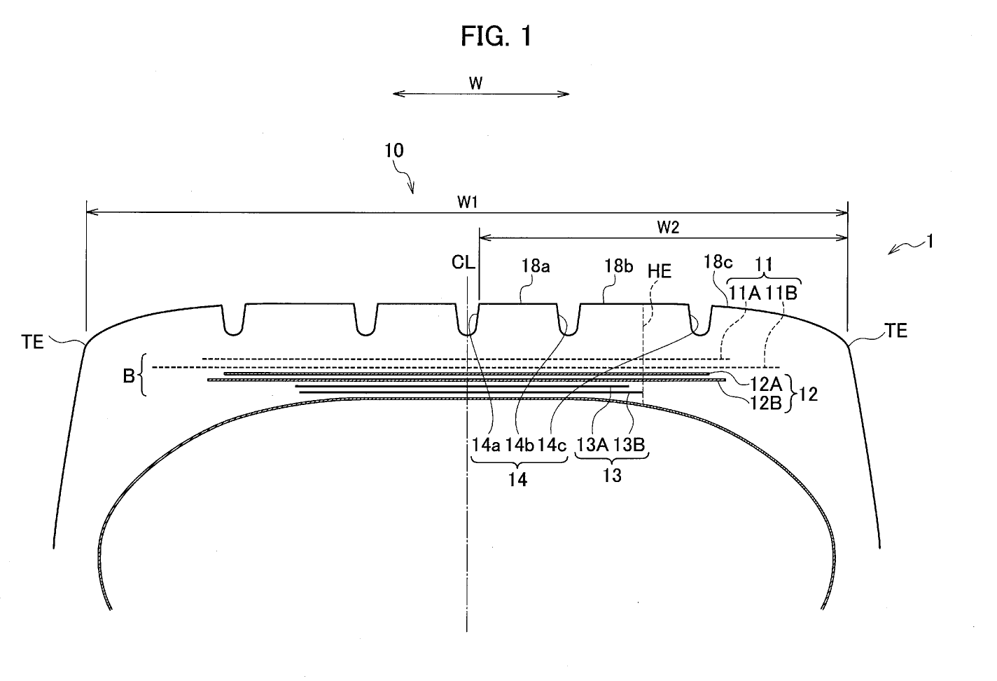

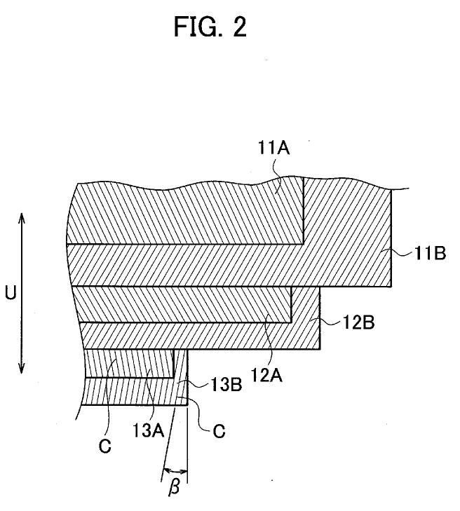

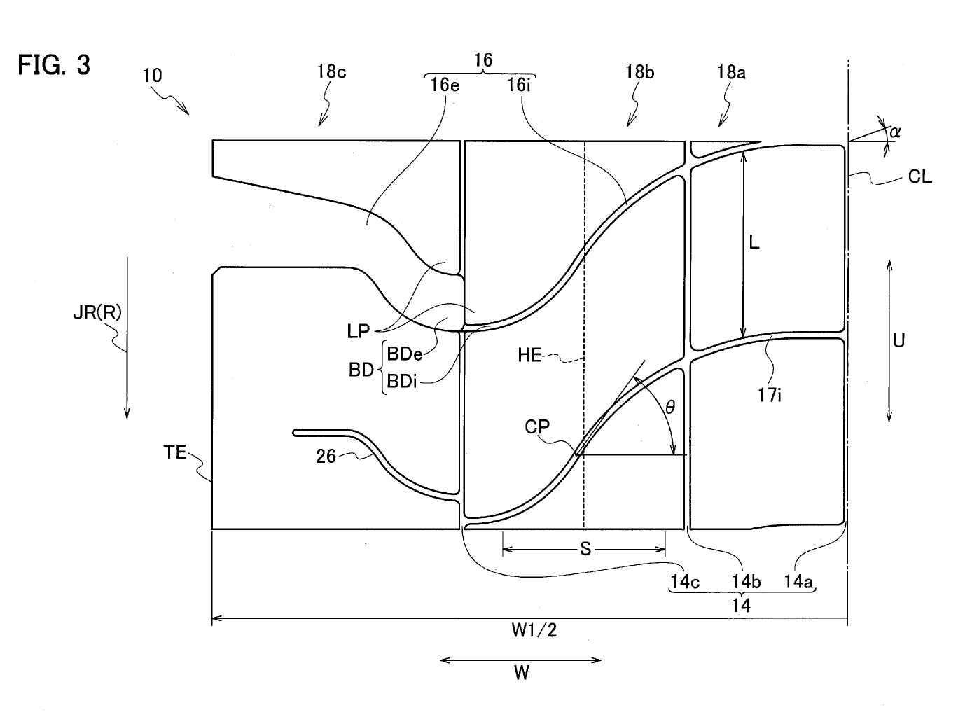

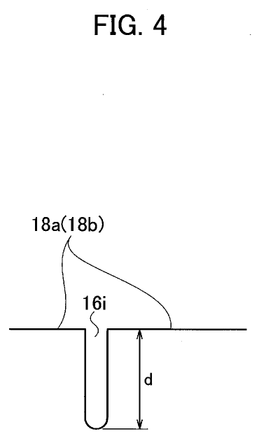

FIG. 1 is a cross-sectional view of a construction vehicle tire in the tire width direction along the tire radial direction according to an embodiment (hereinafter referred to as the present embodiment) of the present invention. FIG. 2 is an explanatory diagram illustrating a belt configuration of the construction vehicle tire according to the present embodiment. FIG. 3 is a plan view illustrating a tread pattern in the construction vehicle tire according to the present embodiment. In FIG. 3, in consideration of the drawing, the upper side of the space and the lower side of the space are drawn using not by a break line but by a straight line. FIG. 4 is a cross-sectional view of an inner lateral groove formed in the tread part of the construction vehicle tire according to the present embodiment.

As shown in FIG. 1, the construction vehicle tire 1 according to the present embodiment includes a plurality of belt plies. Specifically, as shown in FIGS. 1 and 2, a tread part 10 of the construction vehicle tire 1 for according to the present embodiment includes a protection belt ply 11 including two protection belts 11A and 11B, a main crossed belt ply 12 including two main crossed belts 12A, 12B, and a small crossed belt ply 13 including two small crossed belts 13A, 13B.

As shown in FIG. 1 and FIG. 2, in the construction vehicle tire 1, the main crossed belt ply 12 is arranged on the outer side of the small crossed belt ply 13 in the tire radial direction. The protection belt ply 11 is arranged on the outer side of the main crossed belt ply 12 in the tire radial direction.

In the present embodiment, the angle θ (see FIG. 2) formed by the cord C constituting the small crossed belt ply 13 and a tire circumferential direction U is in the range of 4 to 10°, so that the small crossed belt ply 13 is constituted by a high angle belt. The angle formed by the cord constituting the main crossed belt ply 12 and the tire circumferential direction U is in the range of 18 to 35°. The angle formed by the cord constituting the protection belt ply 11 and the tire circumferential direction U is in the range of 22 to 33°.

As shown in FIG. 3, in the construction vehicle tire 1 according to the present embodiment, the tread part 10 includes a plurality of block rows partitioned by a circumferential groove 14 extending in the tire circumferential direction U or a tread end TE (the definition of the tread end is described later), which is the end of the tread part 10 in a tire width direction W, and a lateral groove 16 extending in the tire width direction W. Here, the circumferential groove 14 is constituted by a circumferential groove 14a extending along the tire circumferential direction on a tire equator line CL, a circumferential groove 14b located between a center land part 18a adjacent to the circumferential groove 14a and a second land part 18b arranged on the outer side of the center land part 18a in the tire width direction W, and a circumferential groove 14c located between the second land part 18b and a shoulder land part 18c.

Further, in the present embodiment, the lateral groove 16 includes an inner lateral groove 16i which is open to the circumferential groove 14a, extends to the outer side of the tire in the tire width direction, crosses the center land part 18a and the circumferential groove 14b, and crosses the second land part 18b to be open to the circumferential groove 14c, and an outer lateral groove 16e (lug groove) which is open to the circumferential groove 14c and crosses the tread end TE across the shoulder land part 18c. The groove width of the outer lateral groove 16e is caused to be wider than that of the inner lateral groove 16i.

In addition, both the inner lateral groove 16i and the outer lateral groove 16e extend in a curved line, and form no corner portion.

In the construction vehicle tire 1 according to the present embodiment, the length W2 of the lateral groove 16 in the tire width direction W is set to be not less than 30% of the length W1 of the tread part 10 in the tire width direction W, that is, the tread width.

The inner lateral groove 16i is inclined with respect to the tire width direction W so that a portion of the lateral groove 16 located on an outer side in the tire width direction grounds ahead from the tire equator line CL to the high angle belt end HE when the tire rotates in a tire normal rotation direction. The high angle belt end HE is the end of the belt having an angle of 10° or less formed by the cord constituting the belt ply and the tire circumferential direction, and in the present embodiment, the high angle belt end HE is the belt end of the small crossed belt ply 13 where the belt end extends along the tire circumferential direction U.

The inner lateral groove 16i has an inflection point CP at which the orientations of a concavity and a convexity with respect to the tire circumferential direction U change as the inner lateral groove 16i goes to the outer side of the tire in the tire width direction on at least one side of the tire equator line CL.

The lateral groove 16 extends by gradually increasing an inclination angle with respect to the tire circumferential direction U from the inflection point CP to the one side R of the tire in the tire circumferential direction and the outer side of the tire in the tire width direction so that the angle becomes close to 90°, and further extends to the other side of the tire in the tire circumferential direction (side opposite to the one side R of the tire in the tire circumferential direction) and the outer side of the tire in the tire width direction while gradually reducing the inclination angle with respect to the tire circumferential direction U, so that the lateral groove 16 has a bent groove part BD that forms a curved convex land portion LP with respect to the one side R of the tire in the tire circumferential direction. In the present embodiment, the inner half portion BDi of the bent groove part BD in the tire width direction is formed by the inner lateral groove 16i, and the outer half portion BDe of the bent groove part BD in the tire width direction is formed by the outer lateral groove 16e.

The end of the inner lateral groove 16i on the circumferential groove 14c side is open to the circumferential groove 14c so as to be parallel to the tire width direction W, and the end of the outer lateral groove 16e on the circumferential groove 14c side also is open to the circumferential groove 14c so as to be parallel to the tire width direction W. The inner lateral groove 16i and the outer lateral groove 16e are open to the circumferential groove 14c so that the groove wall positions on the one side R of the tire in the tire circumferential direction are aligned.

In addition, in the shoulder land part 18c, a second outer lateral groove 26 is formed at a position apart from the outer lateral groove 16e in the tire circumferential direction at a predetermined interval. The groove width of the second outer lateral groove 26 is narrower than that of the outer lateral groove 16e.

The second outer lateral groove 26 is open to the circumferential groove 14c. The second outer lateral groove 26 extends from the position that is open to the circumferential groove 14c to the other side of the tire in the tire circumferential direction and the outer side of the tire in the tire width direction so as to have a curved convex shape with respect to the one side R of the tire in the tire circumferential direction, and further is bent in the tire width direction and linearly extends along the tire width direction, and terminates in the shoulder land part 18c.

In addition, between the inner lateral grooves 16i adjacent to each other in the tire circumferential direction U, a second inner lateral groove 17i that has the same shape as the inner lateral groove 16i, is open to the circumferential groove 14c, and reaches the tire equator line CL is arranged. The opening position of the second outer lateral groove 26 into the circumferential groove 14c is set to be shifted to the other side of the tire in the tire circumferential direction from the opening position of the second inner lateral groove 17i into the circumferential groove 14c.

In the present embodiment, the one side R in the tire circumferential direction is taken as a tire normal rotation direction JR side. As a result, the bent groove part BD protrudes in a curved convex shape toward the tire normal rotation direction JR side of the tire.

Further, the small crossed belt ply 13 including two small crossed belts 13A, 13B, which is mentioned above, and is arranged, as a high angle belt, that is, a belt having an angle of 10° or less of the cord with respect to the tire circumferential direction, in a belt ply B arranged on the inner side of the tire in the tire radial direction relative to the tread part 10.

In a tread face view (planar view of the tread part 10), the inflection point CP is arranged in the tire width direction range S having ⅛ or less of the tread width W1 (more preferably 1/16 or less) with respect to the high angle belt end HE as the center in the width direction.

Here, the tread width is the “tread width” defined by JATMA YEAR BOOK. Further, the above-mentioned tread end refers to the outermost position in the tire width direction of the tire surface (tread surface) where the tire surface is in contact with the ground in a state in which the tire is assembled to the regular rim, 1 filled with regular internal pressure, and the regular load is applied. The term “regular rim” refers to a standard rim as specified in the following standard according to the size of the tire, the term “regular internal pressure” refers to an air pressure corresponding to the maximum load capacity of a single wheel in the applicable size, which is described in the following standards, and the term “regular load” refers to the maximum load (maximum load capacity) of a single wheel in the applicable size of the following standards. The standard is an industrial standard that is effective in the area where the tire is produced or used, for example, “JATMA YEAR BOOK” of “Japan Automobile Tyre Manufacturers Association” in Japan, “YEAR BOOK” of “THE TIRE AND RIM ASSOCIATION INC.” in the United States, and “STANDARD MANUAL” of “The European Tyre and Rim Technical Organisation” in Europe.

In the present embodiment, the maximum value of the angle θ formed by the inner lateral groove 16i with respect to the tire width direction W is in the range of 20 to 80°. In FIG. 3, the angle θ is the maximum at the inflection point CP.

Further, in the present embodiment, the angle α formed by the inner lateral groove 16i with respect to the tire width direction W at the intersection position of the tire equator line and the inner lateral groove 16i is in the range of 0 to 20°. In FIG. 3, the inner lateral groove 16i is drawn so that a is approximately 0°.

Further, the present embodiment is an embodiment of the construction vehicle tire 1, and the distance L (see FIG. 3) between the inner lateral groove 16i and the second inner lateral groove 17i adjacent to each other in the tire circumferential direction U and the groove depth d (depth along the tire radial direction, see FIG. 4) of the inner lateral groove 16i satisfy the following relationship.

d/L> 1/10

In a case where attention is paid to abrasiveness, the width of the circumferential groove 14 (length in the tire width direction W) is preferably 10 mm or less because the land parts support each other when a force is applied.

On the other hand, in a case where attention is paid to heat radiation property, the width of the circumferential groove 14 (length in the tire width direction W) is preferably larger than 10 mm.

Further, in the construction vehicle tire 1 according to the present embodiment, the circumferential pitch of the inner lateral groove 16i may be configured to be 50 mm or more.

### (Effects)

The effects of the present embodiment will be described below.

The lateral groove 16 of the construction vehicle tire 1 according to the present embodiment has an inflection point CP that is open to the circumferential groove 14a and at which the orientations of a concavity and a convexity with respect to the tire circumferential direction U change as the lateral groove 16 goes to the outer side of the tire in the tire width direction. The lateral groove 16 extends from the inflection point CP to one side R of the tire in the tire circumferential direction and the outer side of the tire in the tire width direction, and further extends to the other side of the tire in the tire circumferential direction and the outer side of the tire in the tire width direction, so that the lateral groove 16 has a bent groove part BD forming a curved convex land portion with respect to the one side R of the tire in the tire circumferential direction.

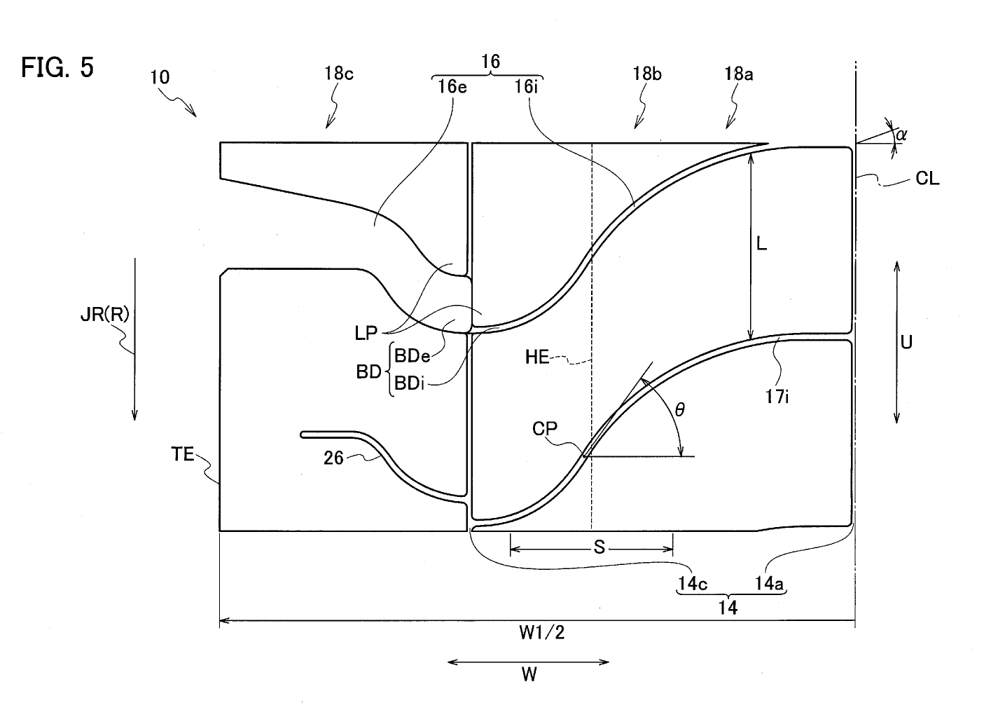

As a result, when the tire is rotated, the tire rubber flows in the tire rotation direction owing to the incompressibility of the tire rubber, so that the circumferential driving force occurs in the vicinity of the apex portion of the pattern, that is, the vicinity of the apex portion of one side R in the circumferential direction in the tire circumferential direction of the land portion partitioned by the bent groove part BD, and has an effect of canceling the braking force generated due to the tire structure. Accordingly, uneven wear is suppressed, so that the construction vehicle tire 1 with improved uneven wear resistance can be provided. As shown in FIG. 5, it is also possible to provide a configuration in which the circumferential groove 14b is not formed.

Further, the lateral groove 16 can have a curved shape as in the present embodiment, whereby it is possible to incline only part of the lateral groove 16 which is desired to incline with respect to the tire circumferential direction U. This makes it easier to ensure rigidity of the tire in the tire width direction. In addition, as compared with the case where the lateral groove 16 has a corner portion, the lateral groove 16 can have an increased inclination, so that the above-described circumferential driving force can be effectively increased.

In addition, in the present embodiment, the small crossed belt ply 13, which is a high angle belt, is arranged in the belt ply B arranged on the inner side of the tire in the tire radial direction relative to the tread part 10, and the inflection point CP is arranged in the tire width direction range having ⅛ or less of the tread width W1 with the high angle belt end HE as the center in the width direction in a tread face view. Therefore, the above-described circumferential driving force can be more effectively generated. FIG. 3 shows an example in which the position of the inflection point CP in the tire width direction is arranged somewhat on the outer side of the tire in the tire width direction relative to the high angle belt end HE, and a remarkable effect is provided in suppressing uneven wear at the ¼ point.

In addition, in the present embodiment, the above one side R of the tire in the tire circumferential direction is set to be the tire normal rotation direction JR side of the tire. Therefore, it is possible to effectively generate the circumferential driving force at the time of the tire normal rotation.

In addition, the inner lateral groove 16i is inclined with respect to the tire width direction so that the portion of the lateral groove 16 located on the outer side in the tire width direction grounds ahead from the tire equator line CL to the high angle belt end HE when the tire rotates in a tire normal rotation direction. As a result, the above-described circumferential driving force can be more effectively increased.

In addition, the maximum value of the angle θ formed by the inner lateral groove 16i with respect to the tire width direction W is in the range of 20 to 80°. As a result, the above-described circumferential driving force can be effectively increased.

In addition, the angle α formed by the inner lateral groove 16i with respect to the tire width direction W at the intersection position of the tire equator line CL and the inner lateral groove 16i is in the range of 0 to 20°. This can effectively prevents the block rigidity from being impaired.

It should be noted that the present application claims priority to Japanese Patent Application No. 2015-137670, filed on Jul. 9, 2015, the entire contents of which are incorporated by reference herein.

### INDUSTRIAL APPLICABILITY

The aspect of the present invention provides a construction vehicle tire in which uneven wear resistance is improved by suppressing a braking force generated in the vicinity of the end of the tire in the tire width direction at the time of tire rotation.

### REFERENCE SIGNS LIST

1 CONSTRUCTION VEHICLE TIRE
10 TREAD PART
13 SMALL CROSSED BELT PLY (HIGH ANGLE BELT)
14 CIRCUMFERENTIAL GROOVE
14a CIRCUMFERENTIAL GROOVE
14b CIRCUMFERENTIAL GROOVE
14c CIRCUMFERENTIAL GROOVE
16 LATERAL GROOVE
B BELT PLY
BD BENT GROOVE PART
CL TIRE EQUATOR LINE
CP INFLECTION POINT
HE HIGH ANGLE BELT END
LP LAND PORTION
JR TIRE NORMAL ROTATION DIRECTION
TE TREAD END
R ONE SIDE R OF TIRE IN TIRE CIRCUMFERENTIAL DIRECTION
U TIRE CIRCUMFERENTIAL DIRECTION
W TIRE WIDTH DIRECTION
W1 TREAD WIDTH
θ ANGLE
α ANGLE

1. A construction vehicle tire comprising a tread part,
wherein the tread part is partitioned in plural by a circumferential groove extending in a tire circumferential direction, and at least one of a tread end of the tread part and a first lateral groove extending in a curved shape along a tire width direction,
wherein the first lateral groove on at least one side in the tire width direction with respect to a tire equator line includes an inflection point at which orientations of a concavity and a convexity with respect to the tire circumferential direction change progressively outward in the tire width direction, and extends from the inflection point toward one side in the tire circumferential direction and toward an outer side in the tire width direction, and further extends toward the other side in the tire circumferential direction and toward the outer side in the tire width direction, so as the first lateral groove to have a bent groove part that forms a curved convex land portion with respect to the one side in the tire circumferential direction.

2. The construction vehicle tire according to claim 1, further comprising a belt ply disposed on an inner side in a tire radial direction of the tread,
wherein a high angle belt is arranged in the belt ply, and
wherein the inflection point is arranged in a tire width direction range having ⅛ or less of a tread width with a high angle belt end as a center in the width direction in a tread face view.

3. The construction vehicle tire according to claim 2, wherein the first lateral groove is inclined with respect to the tire width direction so that a portion of the first lateral groove located on an outer side in the tire width direction grounds ahead from the tire equator line to the high angle belt end when rotating in a tire normal rotation direction.

4. The construction vehicle tire according to claim 1, wherein the one side in the tire circumferential direction is a side in the tire normal rotation direction.

5. The construction vehicle tire according to claim 1, wherein a maximum angle θ formed by the lateral groove with respect to the tire width direction is in a range of 20° to 80°.

6. The construction vehicle tire according to claim 1, wherein at an intersection position of the tire equator line and the first lateral groove, an angle α formed by the first lateral groove with respect to the tire width direction is in a range of 0° to 20°.

7. The construction vehicle tire according to claim 1,
wherein the construction vehicle tire comprises a plurality of the first lateral grooves,
wherein between the first lateral grooves adjacent to each other in the tire circumferential direction, a second inner lateral groove is arranged on the at least one side in the tire width direction with respect to the tire equator line so that the second inner lateral groove opens to the circumferential groove at an outer end reaches the tire equator line,
wherein L and d satisfy a relationship:
d/L> 1/10
where, in the tire circumferential direction, L is a distance between the first lateral groove and the second inner lateral groove adjacent to each other, and d is a groove depth of the first lateral grooves.

8. The construction vehicle tire according to claim 7, wherein the second inner lateral groove has an inflection point at which orientations of a concavity and a convexity with respect to the tire circumferential direction change progressively outward in the tire width direction, and extends from the inflection point toward one side in the tire circumferential direction and toward an outer side in the tire width direction.

9. The construction vehicle tire according to claim 1, further comprising a second outer lateral groove,
wherein the second outer lateral groove is formed at a position apart from the first lateral groove in the tire circumferential direction at a predetermined interval,
wherein a groove width of the second outer lateral groove is narrower than a groove width of a part of the first lateral groove, where the part of the first lateral groove being positioned on the outer side of the circumferential groove in the tire width direction,
wherein an inner end of the second outer lateral groove in the tire width direction, on the at least one side in the tire width direction with respect to the tire equator line, is open to the circumferential groove, and
wherein the second outer lateral groove extends from the position that is open to the circumferential groove toward other side in the tire circumferential direction and toward the outer side in the tire width direction so as to have a curved convex shape with respect to the one side of the tire in the tire circumferential direction, and an outer end of the second outer lateral groove in the tire width direction terminates in a land part.

10. The construction vehicle tire according to claim 9, wherein the second outer lateral groove is further bent in the tire width direction, linearly extends along the tire width direction, and terminates in the land part.
